(19) United States
(12) Patent Application Publication
(10) Pub. No.: US 2007/0274196 A1
(43) Pub. Date: Nov. 29, 2007

(54) SECURE OPTICAL INFORMATION DISC HAVING A RECESS FOR ACCOMMODATING A SECURITY TAG

(75) Inventor: Joel Douglas Bigley, Moscow, PA (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Vidco, Inc., Bingham Farm, MI (US)

(21) Appl. No.: 11/674,462

(22) Filed: Feb. 13, 2007

Related U.S. Application Data
(63) Continuation-in-part of application No. 11/050,296, filed on Feb. 3, 2005, now Pat. No. 7,187,645.
Application No. 11/050,296 is a continuation-in-part of application No. 10/792,352, filed on Mar. 3, 2004, now Pat. No. 6,947,371.
(60) Provisional application No. 60/775,369, filed on Feb. 21, 2006.
(60) Provisional application No. 60/455,284, filed on Mar. 17, 2003.

(51) Int. Cl. G11B 7/26

(52) U.S. Cl. 369/290.1

(57) ABSTRACT

A secure optical information disc comprising an electronic article surveillance tag embedded within a recess of a substrate of the disc structure is disclosed. The tag is placed within the recess such that it does not interfere with reading optically encoded information using a laser beam pick-up assembly such as those used to read DVD, CD, HD and Blu-Ray (BD) discs. The tag is placed within a recess having either no inner wall or an inclined wall.

### CROSS-REFERENCE TO RELATED APPLICATION

This application claims the priority benefit of Bigley, U.S. Provisional Application Ser. No. 60/775,369 filed on Feb. 21, 2006, entitled “Secure Optical Information Disc Having A Recess For Accommodating a Security Tag,” and co-pending Bigley, U.S. patent application Ser. No. 11/050,296, filed on Feb. 3, 2005, entitled “Secure Optical Information Disc Having a Minimized Metal Layer,” which in turn is a CIP that claims the priority benefit of Bigley, U.S. patent application Ser. No. 10/792,352 (now U.S. Pat. No. 6,947,371), filed on Mar. 3, 2004, entitled “Secure Optical Information Disc,” which in turn claims the priority benefit of Bigley, U.S. Provisional Patent Application Ser. No. 60/455,284, filed on Mar. 17, 2003, the contents of each of these referenced applications are incorporated herein by reference in their entirety, including any references therein.

### TECHNICAL FIELD

This invention generally relates to electronic data storage media such as those used to store music, movies, software (including games), and other valuable electronic data assets distributed through retail and/or rental outlets. More particularly, the invention relates to the manufacture of optical data storage discs for carrying an electronically detectable security tag. The security tag potentially embodies a variety of electronic article surveillance (EAS) technologies including ones that generate specific identification codes for inventory control (e.g., RFID and smart tags) as well as ones that, unless deactivated, resonate at a particular frequency (or range) and activate an alarm when passed through an electronic surveillance gate.

### BACKGROUND

Optical data storage discs are the predominant media for storing music, movies and software (including general PC software as well as video game software played upon game consoles connected to televisions/monitors) distributed via retail outlets. Today, music is encoded on an optical data storage disc using compact disc (CD) technology. Software that is distributed through retail outlets is also typically stored on optical data storage discs embodying the CD technology. Movies and games (executed on game consoles) are encoded on optical data storage discs using digital versatile disc (DVD) technology that holds significantly more data than a CD.

Retail theft of optical data storage discs storing valuable digital data assets has received considerable attention from retailers. Initially, theft was deterred through the use of bulky, six by 12 inch cardboard boxes that were difficult for shoplifters to conceal. Later, equally bulky, plastic frames were placed around the boxes to deter theft. While such packaging was an effective deterrent, it created substantial solid waste. Thus, the bulky boxes were abandoned and today, CDs are generally packaged in the well-known “jewel” case. Similarly, DVDs for movies are generally displayed for retail customers within slightly larger plastic cases including one or more optical data storage discs. On the other hand, retailers have resorted to placing DVDs containing game console software in locked cabinets to deter theft.

In the 1990s electronic security mechanisms replaced bulky packaging as a means for discouraging/controlling retail theft. In particular, electronic surveillance tags are now placed on/within optical disc storage retail packaging. Unless deactivated at the checkout counter, the security tags are sensed by surveillance panels positioned at the entrance/exit of a retail establishment. If not deactivated, sensors within the panels detect the security tag when a person attempts to leave with the case containing the security tag and an alarm is activated. A number of such security tag technologies are well known in the art.

Currently electronic security tags are attached to a case within which a DVD, for a movie or game, is held. If the case is taken from a retail establishment before the security tag is deactivated, then an alarm sounds when the security tag passes through security panels at the door. A shortcoming of attaching security tags to a package/case containing an optical disc is that a shoplifter need only remove the disc from the package (or remove the security tag from the package) to evade detection by security panels placed at a store's exit. As a consequence, retailers continue to maintain their game software within locked cases.

Alternatively, and apparently to address the shortcomings of attaching a security tag to a CD case, attaching a security tag to a CD disc having a single substrate has been proposed a number of times in the prior art. These previous proposed CD structures have yet to be adopted commercially by manufacturers and retailers. Introducing a security tag introduces the possibility that the security tag will interfere with playing the disc by a purchaser of the disc. One problem arising from attaching a security device directly to a disc is the need to maintain balance. Another challenge arising from incorporating a security tag into a disc is the need to provide uniform/conforming surfaces at the hub that facilitate proper engagement of the disc hub and a disc player's drive mechanism. Furthermore, a disc that incorporates a security tag should still meet specified space/dimension standards for the particular optical data storage media. Incorporating the security tag into an optical information storage disc in such a way that minimizes disruption to the manufacturing process is yet another challenge when attempting to provide a practical solution to the need to provide a commercially practicable secure disc technology.

Montbriand et al. U.S. Pat. No. 5,347,508 discloses a single-substrate, compact disc structure including an annular groove defined by a recess on one side including generally perpendicular walls and a flat bottom. However, there is no description regarding how such a structure is fabricated in a reliable and commercially practicable way. For example, the Montbriand '508 patent discloses a channel with vertical walls. However, there is no description of the production line that places a tag within the channel and then seals the surface.

### SUMMARY OF THE INVENTION

The present invention is directed to a secure disc arrangement and method for manufacturing the secure disc such that a resulting optical disc is produced in a manner: conforming to the space limitations of the optical disc media standards organizations, providing a sufficiently strong signal to ensure detection of a security tag embedded in the hub of the optical disc media, and meeting production throughput/timing requirements of manufacturers—thereby providing both a technological as well as commercially acceptable solution to a need to control theft of movies, programs and games stored upon optically encoded media (e.g., DVDs).

In particular, in accordance with one aspect of the present invention, a secure optical information storage disc having a reflective information layer is disclosed. The disc comprises a first substrate including a recess characterized by a thin portion of the first substrate beginning at a center hole and continuing to a thick portion of the first substrate. The disc also includes a security tag positioned within the recess of the first substrate. The security tag faces outwardly from the first substrate and is covered within the recess by an over-coating.

In accordance with a second aspect, a secure optical information storage disc having a reflective information layer is disclosed. The disc comprises a first substrate including a channel recess characterized by: (1) a full substrate thickness beginning at a center hole, (2) an inclined edge channel wall, (3) an opposite channel wall, and (4) a partial substrate thickness between the inclined edge and opposite channel walls. The first substrate also includes a thick portion of the first substrate corresponding to the information baring region of the disc. The disc furthermore includes a security tag positioned within the channel recess of the first substrate, the security tag facing outwardly from the first substrate and covered within the recess by an over-coating.

The format and layering of the data tracks differs in accordance with various embodiments of the invention.

The present invention is intended to encompass a variety of optically encoded discs carrying a variety of information assets within a reflective/semi-transmissive layer carried on one or more substrates. The invention is embodied, for example, within DVDs that are encoded with movies, videogame console game software, and software in general. Such embedding prevents separation of a disc from its EAS tag and as such provides a significantly higher barrier to circumvention, by would-be shoplifters, than other known arrangements that merely embed the tag within a case. The present invention is intended to be carried out through the use of a variety of thin film EAS technologies arranged in a variety of topologies and circuits. The invention will be described, by way of illustrative examples, further herein below.

### BRIEF DESCRIPTION OF THE DRAWINGS

While the appended claims set forth the features of the present invention with particularity, the invention, together with its objects and advantages, may be best understood from the following detailed description taken in conjunction with the accompanying drawings of which:

FIG. 1 is a schematic plan view of an exemplary secure disc comprising an annular security tag placed within a notched recess within a substrate of an optical disc;

FIGS. 2a-2f depict cross-sectional views of various types of secure disc formats;

FIGS. 3a-d depict a set of plan views of various security tag coil configurations;

FIG. 4 is a plan view of an assembly line for carrying out DVD manufacturing in accordance with an embodiment of the present invention;

FIGS. 5a and 5b summarize exemplary fabrication stages for DVD-5 and DVD-9 discs comprising security tags embedded between two substrates; and

FIG. 6 is a flowchart summarizing the steps for fabricating a multi-substrate optical disc structure including an embedded security tag.

### DETAILED DESCRIPTION OF THE DRAWINGS

A secure disc, including all formats (e.g., CD, DVD, BLU-RAY/BD, HD etc.), comprises, by way of example and not limitation, a security tag occupying a notched recess within one of potentially multiple substrates of the secure disc (including placing the security tag within a notched recess on a single substrate and covered by a protective layer). An antenna portion of the security tag occupies a portion of the disc such that it does not interfere with the reading of optically encoded/sensed information on the disc. In the case of an optical information disc comprising multiple substrates wherein one of the substrates (e.g. L1) is blank (not stamped), the notched recess is incorporated into the blank substrate. Placing the notched recess on a blank substrate (e.g., L1) joined to a substrate (e.g., L0) through which the optically encoded information is sensed/read enables the dimensions of the security tag to be increased—even to the extent that the security tag's outer perimeter extends into areas/regions of a disc where information is provided on the non-blank substrate (e.g., L0).

In a variation of the groove recess disclosed in Montbriand et al. U.S. Pat. No. 5,347,508, a substrate of the secure disc includes a groove having inner and outer groove walls and a groove bottom surface, wherein at least one of the groove recess walls is substantially non-perpendicular to a bottom surface of the groove. More particularly, at least one wall and the bottom surface meet to form an obtuse angle substantially greater than 90 degrees (e.g. 105 degrees-150 degrees). The one or more non-perpendicular groove recess walls (or alternatively one or more beveled or bull-nose/curved edges on an otherwise perpendicular channel wall) provide a sloped/inclined edge channel wall surface that enhances tolerances for accepting and positioning a security tag at the bottom of the groove during fabrication of a secure disc.

Furthermore, the security tag is substantially balanced with regard to a rotational axis of the secure disc. In an embodiment of the invention the security tag is ring-shaped (i.e., defined by concentric circular inner and outer edges). Thus, when concentrically placed within a notched recess of a substrate of the secure disc, the thin film security tag neither unbalances the disc nor interferes with data acquisition from the disc.

The present invention contemplates a variety of thin film EAS sensor technologies/topologies. In particular embodiments of the invention, the security tag is provided in the form of an insulated thin film resonating device including capacitively coupled coiled circuits, carried by an insulating thin film, constituting an inductor/capacitor (LC), or resonant, circuit. The insulating thin film establishes the capacitive aspect of the LC circuit by slightly offsetting pairs of metallic coils that make up the security tag. The paired coils of the security tag have sufficient surface area to resonate when exposed to electromagnetic energy at a frequency within a particular frequency range. Alternatively, a separate capacitor circuit, separate from the metallic coils, provides at least a portion of the capacitive aspect of the security tag.

The signal generated by the security tag of an optical information storage disc is detected by a receiving antenna thereby making it a viable electronic article surveillance anti-theft device capable of discouraging theft of the optical data storage disc.

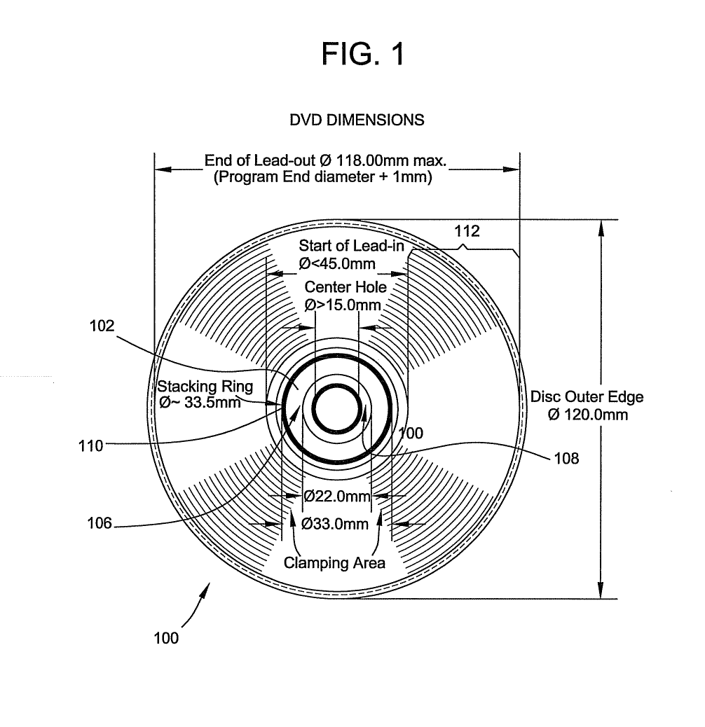

Turning to the drawings, and in particular FIG. 1, the invention is presented in the form of a secure optical data storage disc 100 (also referred to herein as “secure disc 100”) that comprises a security tag 102 placed within a notched recess of a substrate of the secure disc 100 comprising one or more substrates. The security tag 102, by way of example, comprises a polypropylene or polyethylene/Mylar backing material imprinted with a metallic coil circuit. In an embodiment of the invention, the security tag 102 includes a capacitor device that is short-circuited during deactivation (e.g., at a retail establishment's checkout counter). Suitable manufacturers of such tags are All-Tag Security S.A.Z.A.E. of Belgium and Checkpoint Systems, Inc. of Thoroughfare, N.J.

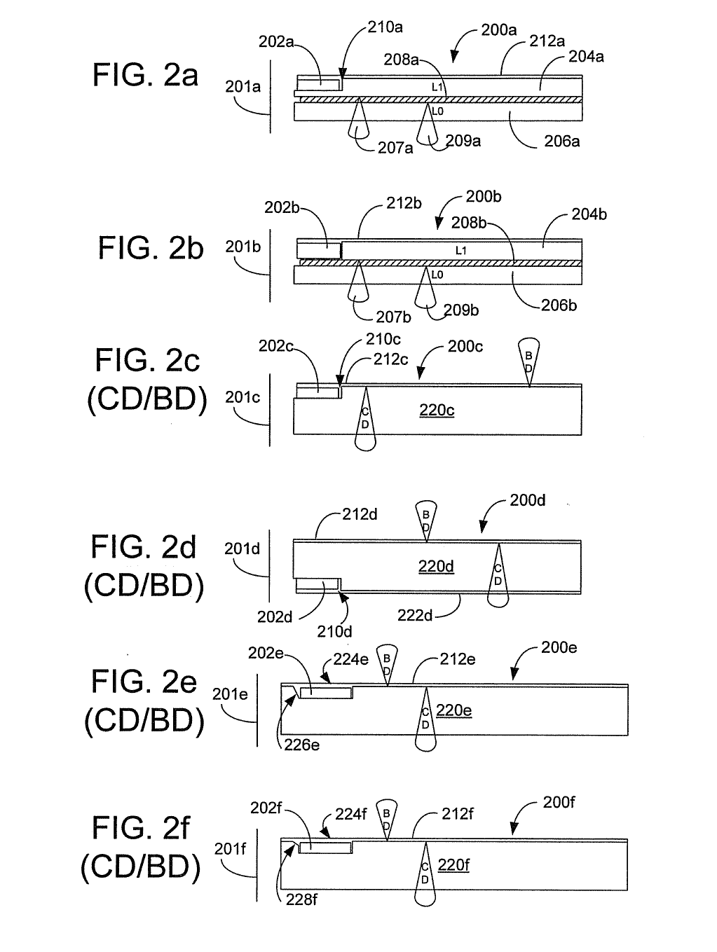

The notched recess includes a single wall, and the notched recess extends from the single wall to a center hole (0-15 mm) on the secure disc 100. In the case where the secure disc 100 comprises multiple substrates, the notched recess is formed in an outward facing surface (top or bottom) of a substrate. By way of example, and not limitation, the depth of the notched recess is with the approximate range of 0.25 mm and 0.40 mm for the security tag 102. The security tag 102 is thinner than the depth of the notched recess. The security tag 102 is sealed in place by an over-coating (lacquer) having a thickness, for example, between 10 and 30 microns in the area of the disc 100 that does not contain the security tag 102, and is preferably greater than 15 microns in thickness. The thickness of the lacquer coating is greater in the area of the disc 100 containing the recess. Multiple passes (including exposing the lacquer to a UV curing lamp) are potentially required to achieve a desired thickness for the over-coating layer that both seals and levels the surface of the disc 100 containing the security tag 102. The layers of various disc structures including recesses for accommodating a security tag are described herein below with reference to FIGS. 2a-f.

A print process thereafter applies artwork to the disc. The lacquer over-coating evens the surface within which the notch is formed. Thus, incorporating the security tag 102 does not affect the overall space requirements for an optically encoded information disc.

In embodiments of the invention, the total thickness of the secure disc 100 including the one or more substrates—and layers formed thereon—does not exceed specified standards (e.g., 1.5 mm for a DVD). In the case of DVD and CD discs the total thickness is preferably about 1.2 mm.

In the illustrative embodiment, based upon DVD standard dimensions, the security tag 102 comprises a thin film LC resonating device that resides, by way of example, within a notched recess positioned primarily within an annular clamping area 106 of the secure disc 100 (and centered with regard to the axis of rotation of the disc 100). The clamping area 106 is defined by a ring with an inner diameter of 22.0 mm and an outer radius of 33.0 mm. In the illustrative embodiment the security tag 102 occupies an area from 15.0 mm to 36.0 mm (Oust outside a stacking ring 110, if present, at a diameter of 33.5 mm). A tolerance of 0.5 mm is recommended to ensure that no part of the tag 102 extends into the center hole region, and thus the inner diameter of the tag 102 is 15.5 mm (−0.5 mm tolerance).

The size/dimensions of the security tag 102 are generally limited by the requirement that the security tag 102 does not interfere with reading encoded data. In the case of a CD, this limits the outer diameter of the tag 102 so as not to interfere with the optically encoded information regions of the disc. However, in the case of a single-sided DVD where the security tag is placed within a notched recess formed in a blank L1 substrate (bonded to the stamped L0 substrate), the diameter/outer dimensions of the security tag can potentially extend beyond the clamping area 106 to nearly the outer edge (e.g., 110 mm diameter) of a DVD. As noted above, the tag 102 does not extend over the rim of the center hole having a diameter of 15.0 mm centered on the rotational axis of the disc 100.

As will be evident to those skilled in the art, the above-described exemplary embodiment can be modified in a number of ways, including, without limitation modifying: any of the identified dimensions (including the disc itself), the size of the security tag 102, the type of encoding of data on the disc (e.g., CD, DVD, etc.), the type of information encoded/embodied in the security tag (e.g., an RFID tag providing a value corresponding to the particular disc—as opposed to merely resonating at a particular frequency to which a sensor is tuned), and the type of data on the data tracks of the disk (e.g., movies, games, application programs, music, etc.). Such modifications are intended to fall within the scope of the present invention.

Having described the dimensions of a secure disc including a security tag with reference to various diameters of an optical information disc, various configurations of secure discs are described with regard to the layers of such discs. Turning to FIGS. 2a-f, a set of partial cross-sectional views are provided of six exemplary configurations of secure discs 200a-f. The letters ‘a’ through ‘f’ following the numerical references distinguish the various depicted embodiments. These simplified cross-sectional views (corresponding to not-to-scale partial side views of various embodiments of secure discs 200 having rotational axes 201) depict the general placement of a security tag 202 and substrate/resin/coating layers of exemplary secure disc structures. The tag 202 preferably includes an adhesive on at least one side to aid its placement on the disc 200.

The security tag 202 is fixed within any of a variety of optical information discs, including DVDs, CDs, BDs, etc. conforming to specified standard dimensions for each particular optical disc technology. A DVD disc, by way of example, has an outer diameter of 120.00 mm (+/−0.30 mm), and the center hole has a diameter of 15.00 mm (+0.15 mm/−0.00 mm). The values in parentheses represent tolerances specified by the standard, ECMA-267 3^{rd} Edition, April 2001, for 120 mm DVD read-only discs. In other embodiments, the outer diameter of the disc is substantially less than 120 mm, and in yet other embodiments the substrates/media are non-circular (but balanced in relation to a rotational axis). The above-specified dimensions and tolerances are intended to be exemplary and differ in alternative embodiments of the invention.

By way of example, in the case of DVDs (see, FIGS. 2a and 2b), a stamped/L0 substrate 206 is approximately 0.6 to 0.5 mm (but may be thinner to accommodate multiple readable layers on a side) across the entire diameter range from the center hole to the outer edge. A blank/L1 substrate 204, on the other hand narrows proximate the center hole to form a notched recess 210a. As shown in FIG. 2a, the notched recess 210a, at the portion of the blank/L1 substrate 204a proximate to a rotational axis 201a of a secure disc 200a, accommodates positioning a security tag 202a having a thickness that is less than the depth of the notched recess 210a (e.g. 0.25 to 0.40 mm). The notched recess 210a faces away from the two optical information baring surfaces (a reflective layer and a semi-transmissive layer indicated by laser beam symbols 207a and 209a, respectively) on dual-layer disc 200a and thus the recess 210a and tag 202a are not restricted in their outer diameter by data/information bearing portions of the disc 200. For example, the outer diameter of the tag 202a potentially extends into the information bearing regions between diameters of 50 and 100 mm. On the other hand, if the recess resides upon one of the surfaces of the stamped/L0 substrate 206a, then the outer dimension is generally limited by the beginning the lead-in region to the information-bearing portion of the disc begins (e.g., a diameter of about 45 mm). Suitable polycarbonate material for the blank and stamped substrates is provided by Teijin Kasei America of Alpharetta, Ga.

A bonding layer 208a, approximately 0.1 mm (0.04-0.07 mm recommended), holds/bonds the two substrates together to form a DVD structure. As shown in FIG. 2a, the bonding layer 208a potentially extends nearly all the way to the center hole. Therefore the total thickness of the DVD structure is approximately 1.20 mm. (+0.30 mm/−0.06 mm). A suitable manufacturer of a bonding resin for the bonding/adhesive layer 208a is Nagase California Corp. of Sunnyvale, Calif.

With continued reference to FIG. 2a, a lacquer over-coating 212a seals the tag 202a within the secure disc 200a structure. The security tag 202a is thinner than the depth of the notched recess. The over-coating 212a also levels the surface of the disc 200a in the region of the notched recess 210. The over-coating 212a has a thickness, for example, between 10 and 30 microns in the area of the disc 200a that does not contain the security tag 202a, and is preferably greater than 15 microns in thickness. The thickness of the lacquer over-coating 212a is greater in the area of the disc 200a proximate the rotational axis 201a containing the recess 210a.

The over-coating 212a is applied prior to printing labels/artwork on the blank/L1 substrate 204a. The over-coating 212a is preferably applied through a silk screen or offset printing process that utilizes a wiper/blade to spread the lacquer onto the surface of the screen, through the screen, and onto the disc 200a. Other dispensing methods can be used. Multiple lacquer application passes (including exposing the lacquer to a UV curing lamp) are potentially required to achieve a desired thickness for the over-coating layer that both seals and levels the surface of the disc 100 containing the security tag 102. Other ways of applying the lacquer are contemplated in alternative embodiments.

Turning to FIG. 2b, an alternative multi-substrate secure disc 200b structure is illustratively depicted. While similar to the structure depicted in FIG. 2a, the multi-substrate disc 200b includes a recess created by a blank/L1 substrate 204b having a differing center hole radius that differs from a center hole radius of stamped/L0 substrate 206b. The larger center hole diameter of the blank/L1 substrate 204b accommodates a potentially thicker security tag 202b. In this embodiment, the bonding layer 208b is cured/hardened prior to applying the security tag 202b to prevent the security tag 202b from sinking into the resin of the bonding layer 208b. In all other respects, the structure of the disc 200b is the same as disc 200a.

Having described two exemplary DVD structures, attention is directed to single-substrate secure discs, depicted by way of example in FIGS. 2c-2f, incorporating a recess on either the metalized or non-metalized side. In single-substrate embodiments, such as BLU-RAY and CD discs, a single substrate 220 is approximately 1.19 mm. It is noted that in each of the FIGS. 2c-2f, two beams are depicted. A first beam, labeled “CD” corresponds to a CD disc. A second beam, labeled “BD” corresponds to a BLU-RAY disc. The two types of discs are distinguished, among other things, by the substrate side from which the optically sensed information on a reflective/metalized layer (between a substrate 220 and over-coating 212) is read. In the case of a BD disc, a laser passes through a relatively thin over-coating 212 layer (e.g., less than 0.1 mm thick) and does not pass through the substrate 220. In the case of a CD disc, a laser beam passes through a relatively thick substrate (e.g., 1.1 mm thick).

Referring to FIG. 2c, a CD/BC disc 200c includes a notched recess 210c similar to the one described above with reference to FIG. 2a. In this case, the notched recess 210c interrupts a stamped surface of a substrate 220c upon which information is digitally encoded. In this case, the diameter of the security tag 202c is limited by the lead-in region for the information-bearing portion of the disc 200c. An over-coating layer 212c seals the reflective surface as well as the security tag 202c.

Referring to FIG. 2d depicting an alternative embodiment of a secure CD/BD disc 200d, a notched recess 210d is formed on the side of a substrate 220d that is opposite the side containing the reflective/metalized layer and over-coating 212d. A second over-coating layer 222d seals the security tag 202 within the recess.

In accordance with yet other embodiments, such as the one depicted in FIG. 2e, a security tag 202e is placed within a channel recess 224 formed within a substrate 220e. The security tag 202e is sealed in place by an over-coating 212e. In contrast to known channel structures, a CD/DVD secure disc structure 200e includes one or more inclined channel walls. In the illustrative example, a channel wall 226e, forming an obtuse angle with a channel base 228e introduces tolerances with regard to the placement of the security tag 202e on the substrate 220e during fabrication of the secure disc structure 200e. The angle formed by the channel wall 226e and the channel base 228e is, for example, substantially greater than 90 degrees (e.g. 105 degrees-150 degrees). In yet other embodiments, tolerances are introduced by beveling or bull-nosing one or both sides (vertical walls) of the channel recess 224. An example of such embodiment, including a bevel 228f, is depicted in FIG. 2f. The one or more non-perpendicular groove recess walls (or alternatively one or more beveled edges on an otherwise perpendicular channel wall) provide a sloped surface that enhances tolerances for accepting and positioning a security tag at the bottom of the groove during fabrication of a secure disc. Furthermore, while depicted as a recess on a metalized side of a single substrate in FIGS. 2e and 2f, as noted previously above, the recess for the security tag is formed on a non-metalized side of a single substrate disc in alternative embodiments.

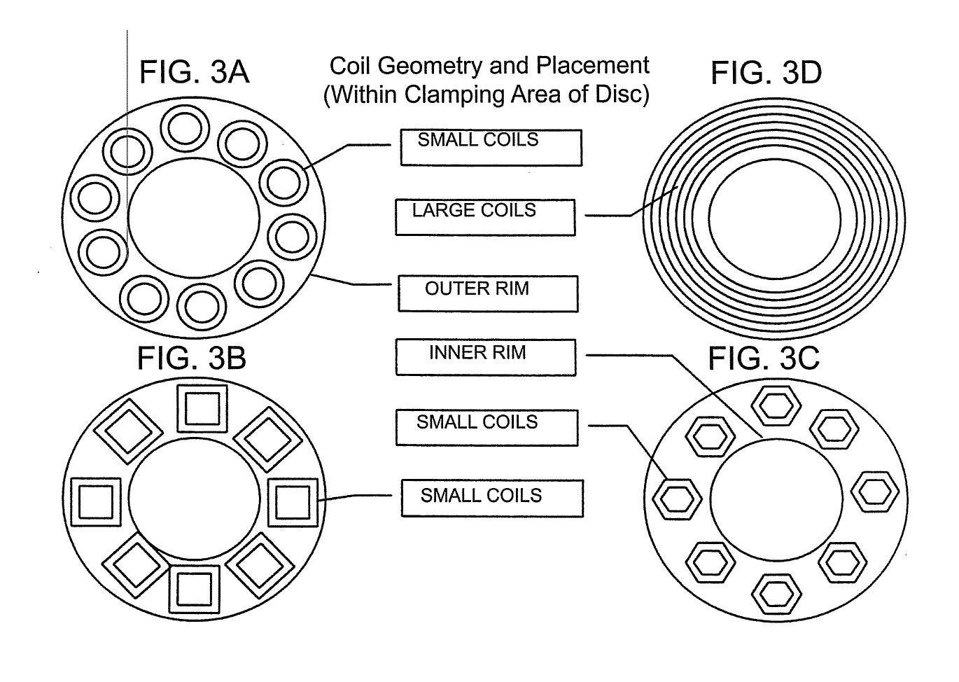

Turning briefly to FIGS. 3a-d, a set of exemplary configurations/geometries for the security tag are provided. As explained previously above, the security tag fits, by way of example, within the clamping area of a DVD or other optically readable data storage disc. The coils of the security tag can take any of a number of shapes and sizes—subject to the space limitations imposed by the disc geometry. FIGS. 3a, 3b and 3c schematically depict embodiments of miniature coil configurations. In these embodiments signal strength is enhanced by creating multiple replicated coil pairs and distributing the coils around the perimeter of a ring substrate for the security tag 202. FIG. 3d, on the other hand, derives signal strength through the use of large ring-shaped coils that conform to the ring-shape of the security tag 202's substrate. Alternative embodiments of the invention utilize other shapes/coil layouts.

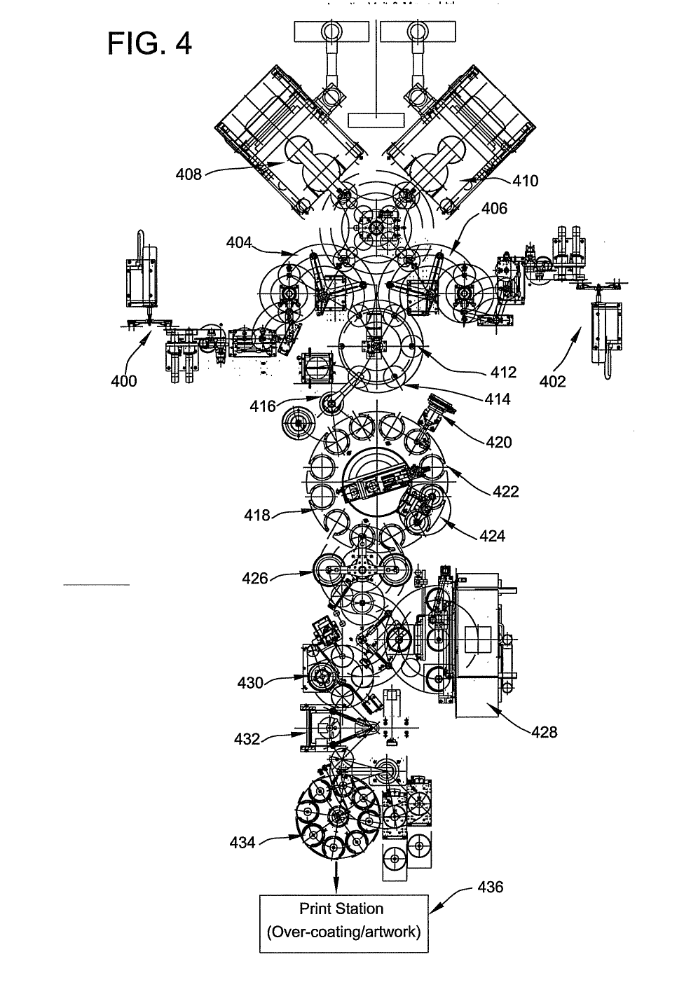

Turning to FIG. 4 a portion of a DVD assembly line is depicted for manufacturing the DVD structure depicted in FIG. 2a. The illustrative set of machines manufactures either DVD-5 or DVD-9 (depending upon whether information-bearing layers are carried on both substrates prior to bonding the two together). Each substrate is initially produced by a molding/stamping sub-assembly 400 or 402 such as one provided by, for example, Meiki Molding of Nagoya, Japan. Alternative providers of equipment include Singulus, of Kahl am Main, Germany. Transfer arms 404 and 406 transfer the substrates to sputtering machines 408 and 410 made by UNAXIS of Luxembourg, if the substrate is a non-blank substrate. The security tag 202a is placed within the recess 210a any one of multiple potential points in the manufacturing process prior to applying the over-coating 212a. Thus, the tag 202a is applied to a molded substrate: before sputtering (if needed), after sputtering and before bonding the two substrates, or alternatively after curing the joined substrates (but prior to applying the over-coating 212a).

The sputtered or blank substrate is transferred by the transfer arms 404 and 406 to an indexing carousel 412. In an embodiment of the invention, while the substrate is laying, inside face down, on the indexing carousel 412 at position 414 (before applying a bonding resin and consolidating the two halves to form a single DVD), a tag applicator applies the security tag 202 to the L1 substrate 204a. Thereafter, the DVD halves are transferred by a transfer arm 416 to a consolidating assembly 418. A flipper 420 flips one of the two disc halves in preparation for consolidation while an applicator 422 applies bonding resin to the other half. Thereafter, a consolidator 424 mates the two halves of the disc to render a DVD-5 or DVD-9 disc.

With continued reference to FIG. 4, a spinner assembly/station 426 spins excess bonding resin from the consolidated DVD disc assembly and the bonding resin 208a is cured through exposure to a UV light source at a UV curing station 428. In an alternative exemplary embodiment, the security tag 202a is placed within the notched recess 210a after UV curing and prior to application of the over-coating 212a. After the UV curing station 428 cures the bonding resin 208a, excess resin is removed from the edges at a cleaning station 430. Thereafter, the cleaned disc is transferred to an inspection station 432, and if accepted, the disc is passed to a disc accumulation spindle station 434.

After accumulating on a set of discs on a spindle, the discs are transferred to a print station. At the print station 436, an over-coating is applied to seal the security tag 202a within the DVD structure (and level the disc surface containing a recess within which the tag 202a resides). Thereafter, any desired artwork is printed over the non-readable surface of the disc (opposite the surface through which a laser beam passes when the DVD disc is played).

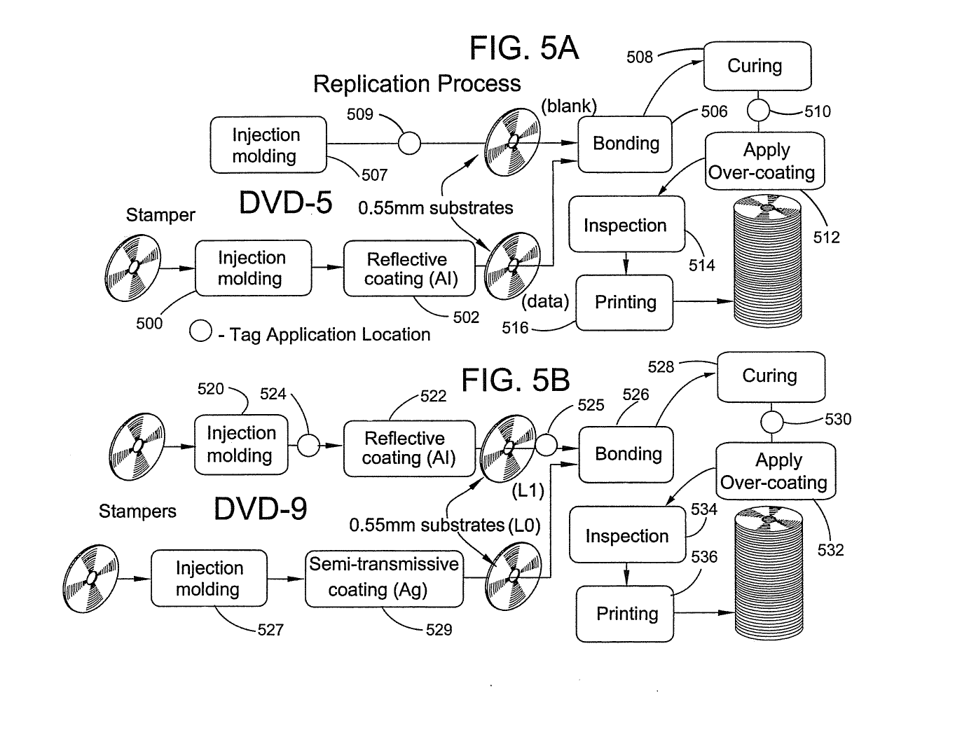

Turning to FIGS. 5a and 5b, a set of schematic flow diagrams illustratively depict/summarize the primary stages for creating replicated DVD-5 and DVD-9 discs, respectively. In each set of steps, multiple potential locations for applying the tag to an out-facing surface of a substrate, including a recess, are identified. These figures schematically depict two alternative sequences of operations performed by the manufacturing line depicted in FIG. 4. With reference to FIG. 5a, a stamper line generates an embossed substrate at stage 500. Thereafter, the reflective (aluminum) coating is applied (sputtered) at stage 502 to render the data bearing half of the disc. The disc half containing the reflective metal layer is transferred to a bonding stage 506, wherein the data half is mated with a blank substrate provided by molding stage 507. A first potential point for applying the security tag 202 to the blank substrate arises (at stage 509) prior to bonding the blank and stamped substrates together at stage 506. In a particular example, the tag 202 is placed within the recess of the blank substrate while the substrate lies inside face down on the carry table (either before or after the sputtering stations). After the bonding stage 506, described in greater detail above with reference to FIG. 4, the disc is UV cured at stage 508. Thereafter, a second potential point for applying the tag 202 arises prior to printing on the DVD substrate. By way of alternative example, during stage 510 the tag 202 is applied (as an alternative to stage 509). In a particular example, the tag 202 is placed within the recess of the blank substrate while the disc lies on the UV carousel (following UV curing)—prior to transfer to the accumulation spindles (i.e., stacked). Alternatively, the tag is applied prior to over-coating and printing while on the print carousel. Thereafter during stage 512 an over-coating seals the disc 200 and levels the disc surface containing the recess and tag 202. At stage 514 the disc 200 is inspected and thereafter printing is placed upon the non-readable surface of the DVD during stage 516.

With reference to FIG. 5b, a stamper line generates an embossed substrate at stage 520. Thereafter, the reflective (aluminum) coating is applied (sputtered) at stage 522 to render one data bearing half of the DVD-9 disc—including the sputtered mirror/ID band as well. The disc half containing the reflective metal layer is transferred to a bonding stage 526, wherein the data half containing the reflective metal (Al) layer is mated with a second data half containing a semi-transmissive metal (Ag or Au) layer provided by stamper stage 527 and semi-transmissive layer stage 529. A first potential point for applying the security tag 202 to the substrate that bears the “reflective” layer arises (at stage 524) prior to sputtering the reflective layer at stage 522. This step is performed, for example, while the substrate lies on the carry table. A second potential point for applying the security tag 202 arises (at stage 525) after sputtering stage 522 but before the bonding stage 526. This step is performed, for example, before the sputtered substrate is transferred from the carry table to the bonding assembly. After the bonding stage 526, described in greater detail above with reference to FIG. 4, the DVD-9 disc is UV cured at stage 528. Thereafter, a third potential point for applying the tag 202 arises prior to printing on the DVD substrate. By way of alternative example, during stage 530 the tag 202 is applied (as an alternative to stage 524 and stage 525). In a particular example, the tag 202 is placed within the recess of the blank substrate while the disc lies on the UV carousel (following UV curing)—prior to transfer to the accumulation spindles (i.e., stacked). Alternatively, the tag is applied prior to over-coating and printing while on the print carousel. Thereafter, during stage 532 an over-coating seals the disc 200 and levels the disc surface containing the recess and tag 202. At state 534 the disc 200 is inspected and thereafter printing is placed upon the non-readable surface of the DVD-9 disc during stage 536.

A set of steps for a CD or BD production line is similar to the ones depicted in FIGS. 5a and 5b described herein above. After stamping the substrate (approx. 1.1 mm), the stamped surface is covered with a reflective material (e.g., aluminum). Either before or after applying the reflective layer, the security tag 202 is placed within the recess (see, e.g., FIGS. 2c-2f) on the substrate. Thereafter, an over-coat is applied to seal the substrate surface containing the security tag 202. If the stamped side of the substrate differs from the one containing the recess, then a second over-coat is applied on the stamped surface. Thereafter, the disc is inspected and a printing layer is applied.

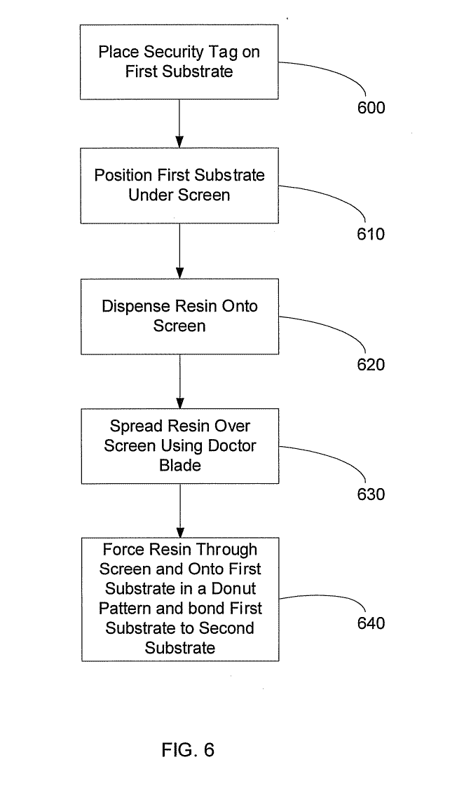

Turning to FIG. 6, a set of steps summarize the assembly of the separate pieces of a DVD structure. After initially placing the security tag on a first substrate during step 600, at step 610 the first substrate is positioned under a screen. Thereafter, at step 620 resin is dispensed onto the screen. Next, at step 630 a doctor blade spreads the resin over the screen. Thereafter, at step 640 a squeegee forces the resin through the screen and onto a surface of the first substrate in a donut pattern. Thereafter, the first substrate is bonded to a second substrate.

In view of the many possible embodiments to which the principles of this invention may be applied, it should be recognized that the embodiments described herein with respect to the drawing figures are meant to be illustrative only and should not be taken as limiting the scope of invention. Furthermore, the illustrative steps may be modified, supplemented and/or reordered (at least in part) without deviating from the invention. Therefore, the invention as described herein contemplates all such embodiments as may come within the scope of the following claims and equivalents thereof.

What is claimed is:

1. A secure optical information storage disc comprising:
a first substrate including a recess characterized by a thin portion of the first substrate beginning at a center hole and continuing to a thick portion of the first substrate;
a security tag positioned within the recess of the first substrate, the security tag facing outwardly from the first substrate and covered within the recess by an over-coating; and
a reflective information layer.

2. The secure disc of claim 1 wherein the disc structure conforms to structural specifications for a DVD disc.

3. The secure optical data storage disc of claim 1 wherein the disc structure conforms to the structural specifications of a BLU-RAY disc.

4. The secure optical disc of claim 1 wherein the optical disc has only a single substrate.

5. The secure optical disc of claim 1 wherein the recess is on a side of the first substrate that does not include the reflective information layer.

6. The secure optical disc of claim 5 wherein the recess extends into an area of the disc from which information is stored on the reflective information layer.

7. A method for manufacturing a secure optical data storage disc comprising a first substrate, a reflective information layer, and a security tag, the method comprising performing, in any order, the steps of:
forming the first substrate including a recess, the first substrate characterized by a thin portion beginning at a center hole and continuing to a thick portion of the first substrate;
applying the reflective information layer to an information baring surface of the disc.
positioning the security tag within the recess of the first substrate, the security tag facing outwardly from the first substrate; and
covering, after the positioning step, the recess by an over-coating thereby sealing the security tag within the recess.

8. The method of claim 7 wherein the applying step is performed on the first substrate, and wherein the applying step occurs prior to the positioning step.

9. The method of claim 8 wherein the positioning step is performed prior to bonding the first substrate to a second substrate.

10. The method of claim 7 wherein the applying step is performed on the first substrate, and wherein the applying step occurs after the positioning step.

11. The method of claim 7 wherein the covering step is performed at a printing station prior to applying a print layer to the disc.

12. A secure optical information storage disc comprising:
a first substrate including a channel recess characterized by:
a full substrate thickness beginning at a center hole,
an inclined edge channel wall
an opposite channel wall
a partial substrate thickness between the inclined edge and opposite channel walls
and a thick portion of the first substrate corresponding to the information baring region of the disc;
a security tag positioned within the channel recess of the first substrate, the security tag facing outwardly from the first substrate and covered within the recess by an over-coating; and
a reflective information layer.

13. The disc of claim 12 wherein the inclined edge channel wall comprises a continuous edge from the substrate upper surface to a base of the channel recess.

14. The disc of claim 13 wherein an angle formed by the inclined edge channel wall and the base of the channel recess is at least about 105 degrees.

15. The disc of claim 14 wherein the angle formed by the inclined edge channel wall and the base of the channel recess is less than about 150 degrees.

16. The disc of claim 12 wherein the inclined edge channel wall comprises a beveled edge.

17. The disc of claim 12 wherein the inclined edge channel wall comprises a bull-nose edge.
